(19) United States
(12) Patent Application Publication
(10) Pub. No.: US 2013/0220118 A1
(43) Pub. Date: Aug. 29, 2013

(54) SEPARATION OF GAS MIXTURES CONTAINING CONDENSABLE HYDROCARBONS

(71) Applicant: Generon IGS, Inc., (US)

(72) Inventors: John A. Jensvold, Benicia, CA (US); Raymond K. M. Chan, Orinda, CA (US); Kyle A. Jensvold, Walnut Creek, CA (US)

(73) Assignee: GENERON IGS, INC., Houston, TX (US)

(21) Appl. No.: 13/772,397

(22) Filed: Feb. 21, 2013

Related U.S. Application Data
(60) Provisional application No. 61/604,615, filed on Feb. 29, 2012.

(51) Int. Cl. B01D 53/14

(52) U.S. Cl. CPC B01D 53/1487
USPC 95/45; 96/4

(57) ABSTRACT

A non-cryogenic system for gas separation includes an absorbent system for removing condensable hydrocarbons from a feed gas. The feed gas is then directed into a gas-separation membrane. The absorbent system includes a liquid absorbent having an affinity for hydrocarbons. The liquid absorbent can be, for example, compressor oil or mineral oil. A chiller and a carbon bed may optionally be positioned between the absorbent system and the membrane. The absorbent is periodically regenerated by reducing the pressure or increasing the temperature of the liquid.

### CROSS-REFERENCE TO PRIOR APPLICATION Priority is claimed from U.S. provisional patent application Ser. No. 61/604,615, filed Feb. 29, 2012, the disclosure of which is hereby incorporated herein.

### BACKGROUND OF THE INVENTION

The present invention relates to the non-cryogenic separation of gas mixtures. The invention provides an improved method and apparatus for removing condensable hydrocarbons from such mixtures.

It has been known to use a polymeric membrane to separate air into components. Various polymers have the property that they allow different gases to flow through, or permeate, the membrane, at different rates. A polymer used in air separation, for example, will pass oxygen and nitrogen at different rates. The gas that preferentially flows through the membrane wall is called the “permeate” gas, and the gas that tends not to flow through the membrane is called the “non-permeate” or “retentate” gas. The selectivity of the membrane is a measure of the degree to which the membrane allows one component, but not the other, to pass through.

A membrane-based gas separation system has the inherent advantage that the system does not require the transportation, storage, and handling of cryogenic liquids. Also, a membrane system requires relatively little energy. The membrane itself has no moving parts; the only moving part in the overall membrane system is usually the compressor which provides the gas to be fed to the membrane.

A gas separation membrane unit is typically provided in the form of a module containing a large number of small, hollow fibers made of the selected polymeric membrane material. The module is generally cylindrical, and terminates in a pair of tubesheets which anchor the hollow fibers. The tubesheets are impervious to gas. The fibers are mounted so as to extend through the tubesheets, so that gas flowing through the interior of the fibers (known in the art as the bore side) can effectively bypass the tubesheets. But gas flowing in the region external to the fibers (known as the shell side) cannot pass through the tubesheets.

In operation, a gas is introduced into a membrane module, the gas being directed to flow through the bore side of the fibers. One component of the gas permeates through the fiber walls, and emerges on the shell side of the fibers, while the other, non-permeate, component tends to flow straight through the bores of the fibers. The non-permeate component comprises a product stream that emerges from the bore sides of the fibers at the outlet end of the module.

Alternatively, the gas can be introduced from the shell side of the module. In this case, the permeate is withdrawn from the bore side, and the non-permeate is taken from the shell side.

An example of a membrane-based air separation system is given in U.S. Pat. No. 4,881,953, the disclosure of which is incorporated by reference herein.

Other examples of fiber membrane modules are given in U.S. Pat. Nos. 7,497,894, 7,517,388, 7,578,871, and 7,662,333, the disclosures of which are all hereby incorporated by reference.

A polymer membrane becomes degraded in the presence of liquid water or water vapor. Therefore, the air directed into the membrane must be substantially free of water. For this reason, it is common to provide some form of dehydration unit which treats the gas before it enters the gas separation module. Polymers have been developed which separate water vapor from a gas. An example of such a polymer is given in U.S. Pat. No. 7,294,174, the disclosure of which is incorporated by reference herein.

The compressed air supplied to a membrane module must also be free of particulates and oil vapor, such as the particles of oil, and the oil vapors, which leak from the compressor. Carbon beds are typically used to remove such particles of oil, and the oil vapor, from the air stream. But excessive humidity also degrades the performance of such carbon beds, which is another reason why the air supplied to the module must be relatively dry.

In addition to a dehydration module and a carbon bed, one may provide heaters, moisture traps, and/or filters between the compressor and the membrane unit, as needed.

A related problem encountered in the non-cryogenic separation of gas mixtures is the presence of condensable hydrocarbons, especially those of high molecular weight, in such mixtures. Such hydrocarbons, if present in the feed stream, may condense in the membrane, and will thus reduce the processing rate with regard to the incondensable components. The condensation thus reduces the overall efficiency of the separation process. If such condensable hydrocarbons are removed from the feed stream, the useful life and stability of the membrane can be readily increased.

Systems of the prior art have addressed the problems caused by the presence of volatile higher hydrocarbons by using process stream chillers and/or carbon beds, positioned upstream of the gas separation unit. A chiller causes the hydrocarbon to condense, so that the hydrocarbon can be conveniently removed as a liquid, before the feed gas flows into the membrane module.

The temperature to which the gas may be chilled is effectively limited, because it is necessary to avoid freezing the components of the feed gas, such as hydrocarbons, water vapor, and/or hydrates which could cause plugging of the process lines. Thus, chillers are of limited utility in reducing the concentration of hydrocarbons in the gas.

Carbon beds are useful in pre-treating a gas mixture, but such beds can quickly become filled with hydrocarbons, and the beds are difficult to regenerate. Such regeneration typically requires extremely high temperatures, and the regeneration process may take considerable time, further reducing the efficiency of the process.

Other examples of prior art devices for removal of hydrocarbons from gas streams are shown in U.S. Pat. Nos. 4,553,983, 5,772,734, and 6,352,575.

The present invention provides an improved method and apparatus for separating gas mixtures containing condensable hydrocarbons, in which such hydrocarbons are removed prior to the separation step.

### SUMMARY OF THE INVENTION

The present invention comprises removing condensable hydrocarbons from a feed gas stream before the stream enters a gas separation module. The condensable hydrocarbons are removed by passing the feed stream through a liquid solvent which absorbs the condensable hydrocarbons. One such solvent is a compressor oil or mineral oil. In general, the solvent should be a non-reactive, scarcely volatile hydrocarbon that has great affinity for other hydrocarbons.

After condensable hydrocarbons have been removed from the feed stream, the stream may optionally be passed through one or more chillers and/or carbon beds, for further removal of contaminates. Then the stream is passed through the membrane module. By removing the condensable hydrocarbons before passing the stream through the membrane module, the useful life of such module can be substantially prolonged.

The absorbent solvent must be regenerated to remove the accumulated hydrocarbons. Regeneration may be performed continuously or in a batch process. Regeneration may comprise lowering the pressure and/or increasing the temperature of the solvent, to release the absorbed hydrocarbon.

The invention therefore has the primary object of providing an improved method and apparatus for non-cryogenic separation of gas mixtures.

The invention has the further object of providing an effective method for removing condensable hydrocarbons from a gas stream, before passing that stream into a gas separation membrane module.

The invention has the further object of extending the useful life of a gas separation membrane module, by reducing the concentration of condensable hydrocarbons in gas streams entering the module.

The invention has the further object of improving the efficiency of gas separation by membranes, by insuring that the gas delivered to such membranes is substantially free of condensable hydrocarbons.

The reader skilled in the art will recognize other objects and advantages of the present invention, from a reading of the following brief description of the drawings, and the detailed description of the invention.

### BRIEF DESCRIPTION OF THE DRAWINGS

FIG. 1 provides a schematic diagram of the apparatus of the present invention.

FIG. 2 provides a table showing measurements taken in an experiment, summarized in Example 2, showing the use of the method of the present invention.

FIG. 3 provides a graph showing the outlet concentration of hexane, in the experiment summarized in Example 2, using the method of the present invention.

### DETAILED DESCRIPTION OF THE INVENTION

The method of the present invention comprises the use of an absorbent solvent to strip out higher molecular weight hydrocarbon contaminates from a raw feed stream, before the stream is directed to a membrane-based gas separation module. Thus, the stream which is presented to the membrane is less condensable than the raw feed stream, and is, for practical purposes, incondensable.

The present invention may include, as an option, the use of one or more process chillers, further to condense out the hydrocarbon contaminates, after the use of the absorbent solvent. Alternatively, one can operate the absorbent process at a low temperature to maximize the removal of the hydrocarbon from the stream. In effect, one can combine the absorbent system and the chiller in the same unit.

The present invention may include, as a further option, the use of an adsorbent carbon bed, further to remove higher hydrocarbons which may still be in the feed gas, including volatilized absorbent solvent.

The feed gas stream is therefore directed through an absorbent solvent, the solvent being chosen such that it has an affinity for high molecular weight hydrocarbons. Passing the gas stream through the liquid solvent causes much or most of the higher molecular weight hydrocarbons to be removed from the stream.

The solvent, which holds an ever-increasing amount of hydrocarbon, must be periodically regenerated. Regeneration can be accomplished by lowering the pressure and/or increasing the temperature of the solvent, to release the absorbed hydrocarbon. The regeneration step can be done either continuously or in a batch process, through the use of a secondary absorbent tank. The regeneration can also be performed through a distillation column, wherein the solvent is separated from the absorbed hydrocarbon, and wherein the solvent is then pumped back to a packed bed or other absorption device.

The solvent used as the absorbent should be a non-reactive, scarcely volatile hydrocarbon that has great affinity for other hydrocarbons. Typical compressor or mineral oils are examples of solvents which could be used.

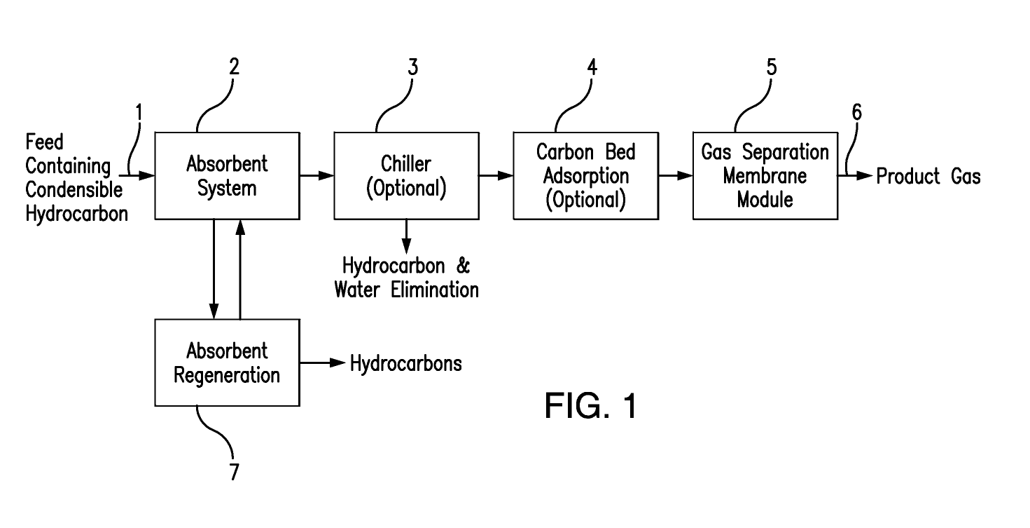

FIG. 1 provides a block diagram illustrating the present invention. A feed gas, containing a condensable hydrocarbon, is provided in conduit 1. The feed gas enters absorbent system 2. The absorbent system can be any device which enables gas-liquid contact. For example, system 2 could be a tank of liquid solvent, through which the feed gas is bubbled.

The output of absorbent system 2 is therefore a feed gas from which much or most of the condensable hydrocarbon has been removed. Optionally, this stream can be directed into chiller 3, which further removes condensable hydrocarbons, and water, by reducing the temperature of the gas and causing the undesired components to condense so that they can be easily removed.

In another optional step, the stream can be passed through carbon bed 4.

Finally, the stream is directed into gas separation membrane module 5. The output 6 of the membrane module comprises a product gas taken from either the bore side or the shell side of the membrane. That is, if the feed gas is air, the product gas could be nitrogen or oxygen. The membrane module operates in exactly the same way as in the prior art, but it operates more efficiently because there are fewer condensable hydrocarbons in the process stream.

The regeneration of the absorbent system is represented in block 7. Although a separate block is shown, the regeneration could be performed at the same location at which the absorption originally occurs. Alternatively, the regeneration step could be performed elsewhere. As indicated on the drawing, an output of the regeneration process comprises hydrocarbons, which have been released from the solvent liquid, and which could potentially be used elsewhere.

As is apparent from FIG. 1, the present invention uses the absorbent system to decrease the amount of organic vapors which enter the membrane module.

The following examples illustrate the operation of the present invention.

### EXAMPLE 1

A nitrogen stream, saturated in a mixture of heptane and nonane, at 100 psig, was passed through a diffuser into a pressurized tank of Sigma S-150 air compressor fluid, purchased from Kaesar Compressors, 511 Sigma Drive, Fredericksburg, Va. 22408. The process stream was passed through 4 liters of the compressor fluid, at a flow rate of 120 cc/min. More than 88% of the heptane, and more than 97% of the nonane, was found to be removed by the absorption process. The total feed stream had an estimated initial hydrocarbon content of 3800 ppm, which was reduced to less than 400 ppm (including an estimated 0.5 ppm from the absorbent) after the absorption process.

### EXAMPLE 2

The purpose of this Example is to show further the feasibility of absorbing hexane, from an air stream, using a packed bed filled with compressor oil. The results, shown below, demonstrate that compressor oil can successfully absorb 90% of the hexane in the air stream. The Example also shows the need for regeneration of the absorbent, because accumulation of hexane in the packed bed increased over time, and eventually reduced the absorption rate to zero.

An air stream containing 1500 ppm of hexane was fed to a packed bed filled with compressor oil. The hexane concentration in the inlet and outlet stream of the packed bed was measured using a hydrocarbon analyzer. The packed bed was made with a 2-inch diameter stainless steel pipe, having a length of about 1.5 feet. The packing material was ceramic and about 0.5 quart of compressor oil (the same oil used as the absorbent solvent in Example 1) was used to fill the packed bed.

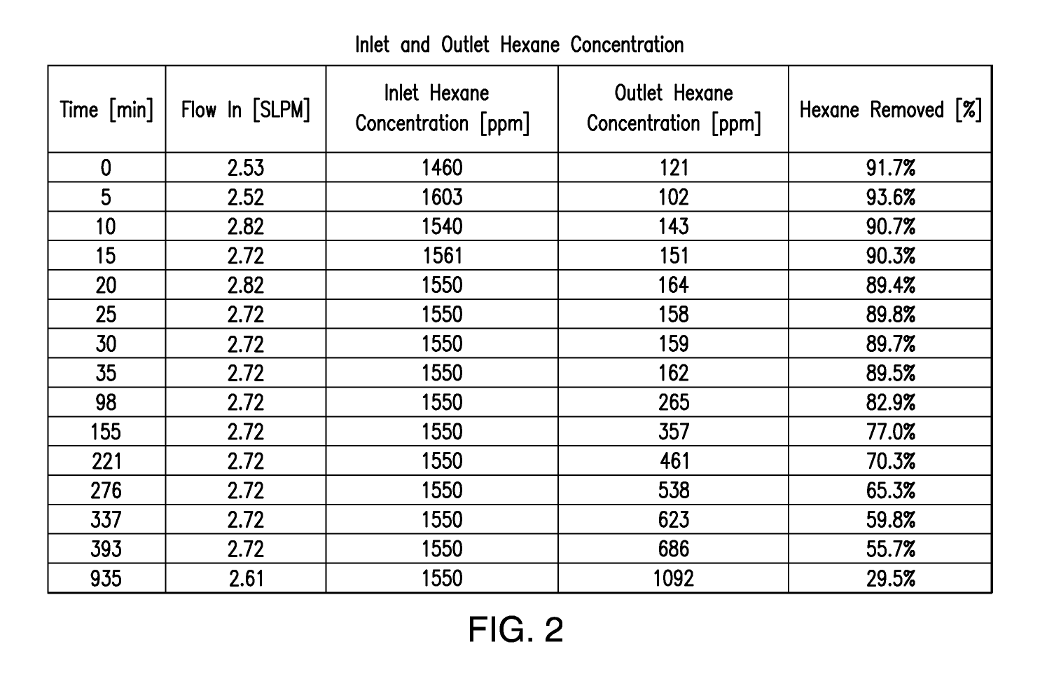

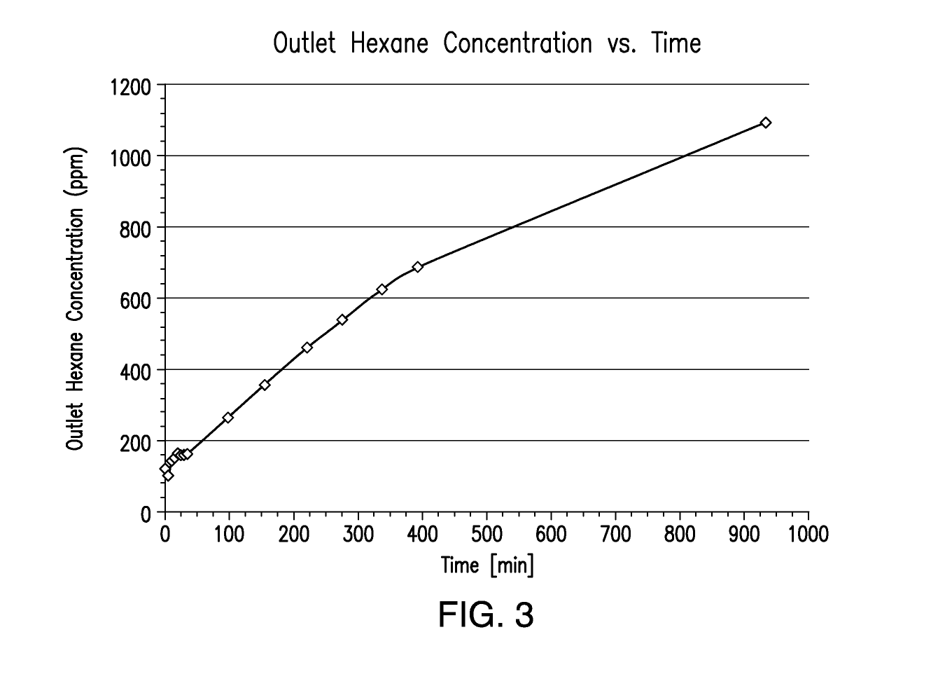

The inlet and outlet concentrations of hexane were measured over time, and the results are shown in the table of FIG. 2. The outlet hexane concentration over time is plotted in FIG. 3.

The present Example shows that compressor oil can be used to absorb hexane. However, in this Example, the absorbent was not regenerated, and the packed bed became clogged with hexane. The packed bed therefore requires regeneration, i.e. removal of the accumulated hexane, in order for the method to work effectively.

The invention can be modified in various ways. As indicated above, the absorbent system 2 can be operated at a reduced temperature, so as to condense more hydrocarbons. Additional chillers and/or carbon beds can be provided. Such modifications, and others which will be apparent to those skilled in the art, should be considered within the spirit and scope of the following claims.

What is claimed is:

1. A non-cryogenic gas-separation system comprising:
a) means for providing a feed gas containing a condensable hydrocarbon,
b) an absorbent system connected to receive the feed gas, the absorbent system comprising a liquid hydrocarbon having affinity for other hydrocarbons, and
c) a gas-separation membrane module connected to receive an output stream of the absorbent system.

2. The system of claim 1, wherein the liquid hydrocarbon used in the absorbent system is selected from the group consisting of compressor oil and mineral oil.

3. The system of claim 2, further comprising a chiller, positioned between the absorbent system and the gas-separation module, the chiller comprising means for cooling the output stream of the absorbent system.

4. The system of claim 3, further comprising a carbon bed, positioned between the chiller and the gas-separation module.

5. The system of claim 1, further comprising means for regenerating absorbent in the absorbent system.

6. A method for non-cryogenic separation of a feed gas containing a condensable hydrocarbon, the method comprising the steps of:
a) passing a feed gas containing a condensable hydrocarbon through a liquid absorbent, to produce a gas stream having a reduced content of condensable hydrocarbons, and
b) directing said gas stream into a gas-separation membrane for separating the gas stream into components.

7. The method of claim 6, wherein step (a) comprises passing the feed gas through a liquid hydrocarbon which has an affinity for hydrocarbons.

8. The method of claim 7, further comprising selecting the liquid hydrocarbon to be a member of the group consisting of compressor oil and mineral oil.

9. The method of claim 6, further comprising chilling said gas stream before performing step (b).

10. The method of claim 6, further comprising chilling said feed gas while performing step (a).

11. The method of claim 9, further comprising passing said gas stream through a carbon bed before performing step (b).

12. The method of claim 6, further comprising the step of periodically regenerating the liquid absorbent.

13. The method of claim 12, wherein the regenerating step is selected from the group consisting of reducing a pressure of the liquid absorbent and increasing a temperature of the liquid absorbent.

14. A method for non-cryogenic separation of a feed gas containing a condensable hydrocarbon, the method comprising the steps of:
a) bubbling a feed gas through a liquid hydrocarbon selected from the group consisting of compressor oil and mineral oil, to produce a gas stream having a reduced content of condensable hydrocarbons, and
b) directing said gas stream into a gas-separation membrane for separating the gas stream into components.

15. The method of claim 14, further comprising chilling said gas stream before performing step (b).

16. The method of claim 14, further comprising chilling said feed gas while performing step (a).

17. The method of claim 14, further comprising the step of periodically regenerating the liquid hydrocarbon.

18. The method of claim 17, wherein the regenerating step is selected from the group consisting of reducing a pressure of the liquid hydrocarbon and increasing a temperature of the liquid hydrocarbon.
